(19) United States
(12) Patent Application Publication
(10) Pub. No.: US 2024/0338620 A1
(43) Pub. Date: Oct. 10, 2024

(54) Automated multicloud process management of onboarding and/or offboarding of a worker

(71) Applicant: CDW LLC, Vernon Hills, IL (US)

(72) Inventors: Christopher Pyle, Delray Beach, FL (US); Erick Bacallao Pedraza, Boca Raton, FL (US)

(21) Appl. No.: 18/131,702

(22) Filed: Apr. 6, 2023

(51) Int. Cl. G06Q 10/0631

(52) U.S. Cl. CPC G06Q 10/063118

(57) ABSTRACT

The following relates generally to methods and systems for electronic onboarding and/or offboarding of a worker. In some embodiments, one or more processors detect a trigger (e.g., a trigger indicating that the worker is to be onboarded). In response to the detection, a profile for the worker may be created by selecting a template. If a license (e.g., an email license, a word processing license, an app license, etc.) with a license type corresponding to a license slot in the selected template is available in a license pool, the license may be assigned to the license slot, and software corresponding to the license may be installed on the worker's computing device. If the license is not available from the license pool, the one or more processors may initiate a purchase of the license from an cloud computing device.

### TECHNICAL FIELD

The present disclosure is generally directed to methods and systems for automating electronic onboarding and/or offboarding of a worker.

### BACKGROUND

Onboarding and offboarding workers at a company is not an easy task to complete efficiently. The worker, depending on her job type or other factors, may require particular licenses (e.g., an email license, a word processing license, app licenses, etc.) and/or physical items (e.g., a laptop, a desktop computer, a server computer, a mobile

device, etc.); and it may not always be easy to determine which licenses and/or physical items the worker requires. Even more, once it is determined which licenses and/or physical items the worker requires, it may not always be clear whether the company already has sufficient licenses and/or physical items to provide the worker with, or whether new licenses and/or physical items must be purchased. Moreover, the process in current systems for purchasing new licenses and/or physical items is cumbersome. Furthermore, current systems for offboarding workers are also cumbersome and inefficient.

Thus, there is an opportunity for platforms and services that improve automated onboarding and offboarding of workers.

### SUMMARY

In one aspect, a computing system for improved automated electronic onboarding or offboarding of a worker may be provided. The computing system may include: one or more processors; and a memory having stored thereon instructions that, when executed by the one or more processors, cause the system to: detect, via the one or more processors, a trigger associated with the worker; in response to the detection of the trigger, create, via the one or more processors, a worker profile for the worker by selecting a template based on a job type of the worker, wherein the selected template comprises: (i) a worker identifying information slot, (ii) a license slot, and (iii) a physical item slot; populate, via the one or more processors, information identifying the worker into the worker identifying information slot; determine, via the one or more processors, if a license with a license type corresponding to the license slot is available in a license pool; if the license is available in the license pool, via the one or more processors: (i) assign the license to the license slot, and (ii) one or both of (a) install, on a worker computing device, software corresponding to the license, or (b) grant the worker computing device access to the software corresponding to the license; and if the license is not available in the license pool, via the one or more processors: (i) initiate a purchase of the license from an cloud computing device, and (ii) one or both of (a) install, on the worker computing device, the software corresponding to the license, or (b) grant the worker computing device access to the software corresponding to the license.

In some embodiments, the trigger comprises an addition of information of the worker to a database.

In some embodiments, the memory having stored thereon instructions that, when executed by the one or more processors, cause the system to: detect, via the one or more processors, a second trigger; and in response to the detection of the second trigger, return, via the one or more processors, the license to the license pool.

In some embodiments, the second trigger comprises an indication that the worker will end employment with a company.

In some embodiments, the license type is an email account license, a word processing license, or an app license.

In some embodiments, the memory having stored thereon instructions that, when executed by the one or more processors, cause the system to: determine, via the one or more processors, a set of physical items based on a physical item type corresponding to a type of physical item of the physical item slot; display, via the one or more processors, representations of physical items of the set of physical items on a computing device; receive, via the one or more processors and from the computing device, a selection of a physical item of the set of physical items; and add, via the one or more processors, an indication of the physical item to the physical item slot.

In some embodiments, the computing device is a worker computing device of the worker, or an administrator computing device of an administrator.

In some embodiments, the memory having stored thereon instructions that, when executed by the one or more processors, cause the system to determine the set of physical items further by: receiving, via the one or more processors, an indication of a parameter associated with the physical item; and determining, via the one or more processors, the set of physical items further based on the parameter.

In some embodiments, the job type is an accounts receivable manager, an accountant, or a software engineer. It is envisioned that any job type may be supported by the present techniques.

In some embodiments, the memory having stored thereon instructions that, when executed by the one or more processors, cause the system to create the template by: presenting, via the one or more processors and at an administrator computing device: (i) a plurality of license types, and (ii) an indication of the job type; receiving, via the one or more processors and from the administrator computing device, a selection of at least one license type of the plurality of license types; setting, via the one or more processors, the license type corresponding to the license slot to be for the selected at least one license type; and setting, via the one or more processors, the template to correspond to the job type.

In another aspect, a non-transitory computer readable medium may be provided. The non-transitory computer readable medium may contain program instructions that when executed, cause a computer to: detect, via one or more processors, a trigger associated with a worker; in response to the detection of the trigger, create, via the one or more processors, a worker profile for the worker by selecting a template based on a job type of the worker, wherein the selected template comprises: (i) a worker identifying information slot, (ii) a license slot, and (iii) a physical item slot; populate, via the one or more processors, information identifying the worker into the worker identifying information slot; determine, via the one or more processors, if a license with a license type corresponding to the license slot is available in a license pool; if the license is available in the license pool, via the one or more processors: (i) assign the license to the license slot, and (ii) one or both of (a) install, on a worker computing device, software corresponding to the license, or (b) grant the worker computing device access to the software corresponding to the license; and if the license is not available in the license pool, via the one or more processors: (i) initiate a purchase of the license from an cloud computing device, and (ii) one or both of (a) install, on the worker computing device, the software corresponding to the license, or (b) grant the worker computing device access to the software corresponding to the license.

In some embodiments, the trigger comprises an addition of information of the worker to a database.

In some embodiments, the non-transitory computer readable medium may contain further program instructions that when executed, cause the computer to: detect, via the one or more processors, a second trigger; and in response to the detection of the second trigger, return, via the one or more processors, the license to the license pool.

In some embodiments, the second trigger comprises an indication that the worker will end employment with a company.

In some embodiments, the license type is an email account license, a word processing license, or an app license.

In some embodiments, the non-transitory computer readable medium contains further program instructions that when executed, cause the computer to: determine, via the one or more processors, a set of physical items based on a physical item type corresponding to a type of physical item of the physical item slot; display, via the one or more processors, representations of physical items of the set of physical items on a computing device; receive, via the one or more processors and from the computing device, a selection of a physical item of the set of physical items; and add, via the one or more processors, an indication of the physical item to the physical item slot.

In some embodiments, the computing device is a worker computing device of the worker, or an administrator computing device of an administrator.

In yet another aspect, a computer system for improved automated electronic onboarding or offboarding of a worker may be provided. The computer system may include one or more processors configured to: detect a trigger associated with the worker; in response to the detection of the trigger, create a worker profile for the worker by selecting a template based on a job type of the worker, wherein the selected template comprises: (i) a worker identifying information slot, (ii) a license slot, and (iii) a physical item slot; populate information identifying the worker into the worker identifying information slot; determine if a license with a license type corresponding to the license slot is available in a license pool; if the license is available in the license pool: (i) assign the license to the license slot, and (ii) one or both of (a) install, on a worker computing device, software corresponding to the license, or (b) grant the worker computing device access to the software corresponding to the license; and if the license is not available in the license pool: (i) initiate a purchase of the license from an cloud computing device, and (ii) one or both of (a) install, on the worker computing device, the software corresponding to the license, or (b) grant the worker computing device access to the software corresponding to the license.

In some embodiments, the trigger comprises an addition of information of the worker to a database.

In some embodiments, the license type is an email account license, a word processing license, or an app license.

In yet another aspect, a computer system for improved automated electronic onboarding or offboarding of a worker may be provided. The computer system may comprise one or more processors configured to: detect an offboarding trigger associated with the worker; in response to the detection of the offboarding trigger, retrieve a worker profile for the worker, wherein the retrieved worker profile includes a template including: (i) a worker identifying information slot populated with information identifying the worker, (ii) a license slot populated with a license assigned to the license slot, and (iii) a physical item slot with a physical item added to the physical item slot; and further in response to detection of the offboarding trigger, both: (i) return the license to a license pool, and (ii) one or both of (a) uninstall, from a worker computing device, software corresponding to the license, or (b) end the worker computing device's access to the software corresponding to the license.

### BRIEF DESCRIPTION OF THE DRAWINGS

FIG. 1 depicts an exemplary computing environment in which the techniques disclosed herein may be implemented, according to some aspects.

FIG. 2 depicts an example screen allowing a worker to make a selection of app licenses, according to some aspects.

FIG. 3 depicts an example screen allowing a worker to make a selection of physical items, according to some aspects.

FIG. 4 depicts an exemplary computer-implemented method of onboarding and removing a worker, according to some aspects.

FIG. 5A depicts an exemplary computer-implemented method of receiving selections of licenses and physical items, according to some aspects.

FIG. 5B depicts an exemplary computer-implemented method of offboarding a worker, according to some aspects.

FIG. 6 depicts an example screen for creating an onboarding workflow, according to some aspects.

FIG. 7 illustrates an example screen enabling an administrator to add, edit, or revoke access to a license.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

The present techniques provide methods and systems for, inter alia, electronic onboarding and/or offboarding of a worker. For example, the present techniques may include detecting a trigger indicating that a worker is to be onboarded. In response to the detection of the trigger, a worker profile may be created for the worker by selecting a template (e.g., based on a job type of the worker, etc.). In some aspects, the user may create a template. An application may include pre-built templates that the user may use as a base for creating and refining a more specialized template. The template may include one or more blocks, each of which corresponds to a respective set of computer-executable instructions (e.g., software stored in a memory of a server device and/or a client device). The blocks may be linked by one or more lines, such that the blocks are represented as being executable in sequence.

The template may include, inter alia, (i) a worker identifying information slot, (ii) a license slot, and (iii) a physical item slot. The license slot may correspond to a license type (e.g., a type of license the company has determined will be assigned for a particular type of worker). If a license with the license type is available from a from a license pool of the company, the license may be assigned to the license slot, and the worker's computer may be granted access to the software corresponding to the license and/or the software corresponding to the license may be installed on the worker's computer. On the other hand, if the license is not available from the license pool, a purchase of the license may be initiated from an cloud computing device before granting access to the software and/or installing the software on the worker's computer.

In some embodiments, an administrator may also create the templates. For example, an administrator may create a template for account receivable clerks that includes a slot for an email license and a slot for a word processing license.

### Exemplary System

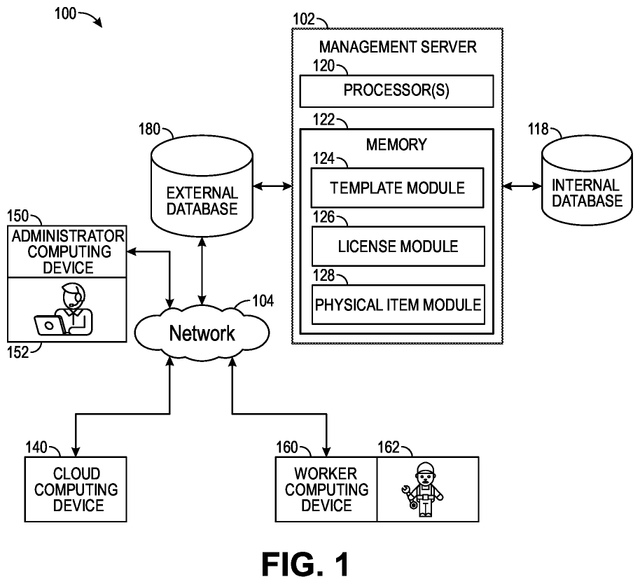

FIG. 1 depicts an exemplary computing environment 100 in which the techniques disclosed herein may be implemented, according to some aspects. The computing environment 100 may include a management server 102, which, in some aspects, may implement the techniques described herein. For example, when worker 162 is being onboarded to a company, the management server 102 may facilitate the onboarding process. Additionally or alternatively, when worker 162 is being offboarded from a company, the management server 102 may facilitate the offboarding process.

The management server 102 may include one or more processors 120 such as one or more microprocessors, controllers, and/or any other suitable type of processor. The management server 102 may further include a memory 122 (e.g., volatile memory, non-volatile memory) accessible by the one or more processors 120, (e.g., via a memory controller). The one or more processors 120 may interact with the memory 122 to obtain and execute, for example, computer-readable instructions stored in the memory 122. Additionally or alternatively, computer-readable instructions may be stored on one or more removable media (e.g., a compact disc, a digital versatile disc, removable flash memory, etc.) that may be coupled to the management server 102 to provide access to the computer-readable instructions stored thereon. In particular, the computer-readable instructions stored on the memory 122 may include modules, such as template module 124, license module 126, and/or physical item module 128.

The template module 124 may include instructions for, inter alia, accessing, creating, and/or storing templates. For example, the template module 124 may include software client libraries for accessing the company's own templates. The templates may be stored at any of the memory 122, an internal database 118 (e.g., a database internal to the company, and storing any information, such as template information, license information, physical item information, etc.), and/or an external database 180 (e.g., a database external to the company, and storing any information, such as template information, license information, physical item information, etc.).

The license module 126 may include instructions related to the licenses. For example, the license module 126 may include software client libraries for accessing a license pool of available licenses. The license pool may be stored at any of the memory 122, the internal database 118, and/or the external database 180.

A license may be for any type of license. Examples of the types of licenses include an email license, a word processing license, an app license, etc. The licenses may have start and end times.

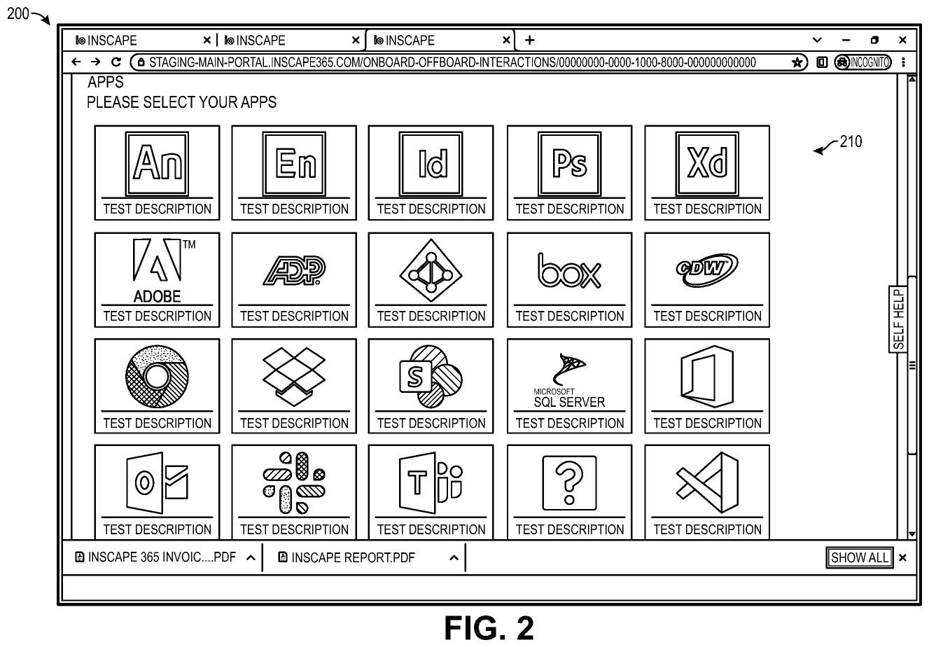

In some examples, the license module 126 may set the licenses to be assigned to the worker 162. In some such examples, the license module 126 presents options for licenses to the worker 162 (e.g., via the worker computing device 160). For instance, in the example of FIG. 2, the licensing module 126 may cause the example screen 200 to be displayed on the worker computing device 160. The example screen 200 includes options for licenses 210 for apps, which the worker 162 may select from. The license module 126 may receive the selection of apps from the worker computing device 160, and assign corresponding licenses to the profile of the worker 162 (e.g. by assigning licenses from the license pool and/or initiating the purchase of licenses; and by one or both of granting access to the corresponding software or installing the corresponding software on the worker computing device 160).

The physical item module 128 may include instructions related to the physical items. For example, the physical item module 128 may include software client libraries for accessing a physical item pool of available physical items. The physical item pool may be stored at any of the memory 122, the internal database 118, and/or the external database 180.

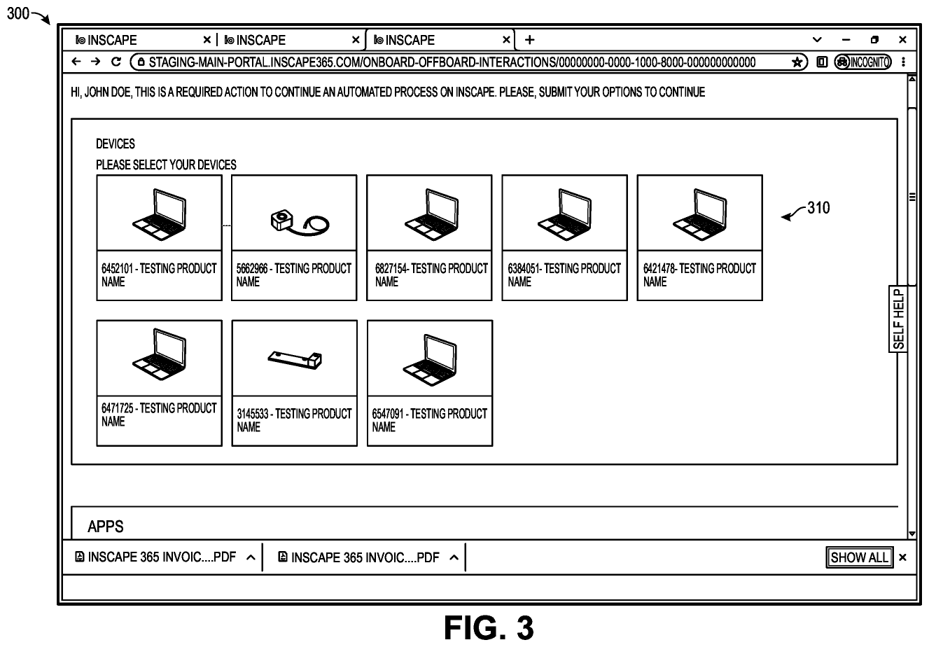

In other examples, the physical item module 128 may provide representations of physical items to the worker computing device 160 for the worker 162 to select from. To this end, FIG. 3 shows an example screen 300 that allows the worker 162 to select from physical items 310. In the illustrated example, the physical items 310 include laptops, a power supply, and a docking station. However, it should be understood that any physical items may be displayed and/or selected from in this fashion.

Furthermore, in some embodiments, the physical item module 128 maintains the physical item pool of available physical items (e.g., a pool of indications of available physical items). It should be appreciated that the physical item pool may comprise an inventory of the physical items available to a company. For example, if a company has three type A laptops available, the physical item pool would indicate that three type A laptops are available.

The worker computing device 160 may be any suitable device, such as a personal computer, a tablet, a phablet, a smart phone, etc.

The administrator computing device 150 may be any suitable device, such as a personal computer, a tablet, a phablet, a smart phone, etc. In some examples, the administrator 152 is a human resources (HR) person of a company that has hired the worker 162.

As mentioned above, if a license is not available (e.g., at the license pool), the company may purchase a license, for example, from an cloud computing device 140. In some embodiments, the cloud computing device 140 is owned by a company that sells licenses. The cloud computing device 140 may be any suitable device, such as a server(s), a personal computer, a tablet, a phablet, a smart phone, etc. In some aspects, the cloud computing device 140 may include a microservice, a software as a service (SaaS) service, one or more private cloud computers, one or more public cloud computers, one or more hybrid cloud computers, or any combination thereof.

Any of the components in the exemplary computing environment 100 may communicate via the network 104 as illustrated. The network 104 may be a single communication network, or may include multiple communication networks of one or more types (e.g., one or more wired and/or wireless local area networks (LANs), and/or one or more wired and/or wireless wide area networks (WANs), such as the Internet).

In operation, the template module 124 may, inter alia, access, create, and/or store templates. A template may include slot(s) for any suitable information. For example, a template may include worker identifying information slot(s), license slot(s), physical item slot(s), etc. Examples of the worker identifying information include the worker's name, social security number, birthdate, address information, etc. The license slot may be for any type of license, as will be discussed further below. The physical item slot may be for an indication of any a physical item of any type. Examples of the physical items include a laptop, a tablet, a phone, a desk, a pair of shoes, a uniform, etc. The slot may also be configured to hold an indication of the type of the physical item, as well as additional information about the physical item. For example, if the physical item is a laptop, the slot may be configured to hold a brand of a manufacturer of the laptop, a processor type of the laptop, a memory capacity of the laptop, etc. In another example, if the physical item is a shoe, the slot may be configured to hold information indicating a shoe size, a brand of the shoe, a type of the shoe (e.g., running shoe, steel toed shoe, etc.).

As will be seen, the use of a template advantageously improves the technical functioning of the onboarding/offboarding system. For example, creating a profile from a template with slots for licenses with specific types reduces the amount of signals that must be sent though the system. For instance, in a system that does not use such templates, the administrator 152 must indicate which types of licenses are to be provided to a new worker each time a new worker is onboarded (e.g., more data must be sent from the administrator computing device 150 to the management server 102 each time a worker is onboarded). Advantageously, techniques described herein leverage a template (which may be selected based on a worker's job type, seniority level, etc.) to reduce the amount of signals that must be sent throughout the system. Indeed, in some embodiments, to create the worker profile, by use of such templates, no (or very little) data must be sent from the administrator computing device 150 to the management server 102.

Each of the modules 124, 126, 128 may implement a specific functionality related to the present techniques, as will be described further below. In some aspects, the modules 124, 126, 128 may work together to onboard a worker 162. For example, when a worker 162 is onboarded, a profile may be created for the worker 162 using a template provided by the template module 124; and the license module 126 may fill slot(s) of the template with licenses from the license pool, while the physical item module 128 fills slot(s) of the template with physical item(s) from the physical item pool.

In another example, to create a new template, the license module 126 may present (e.g., on the administrator computing device 150) potential licenses to add (e.g., as slots) to the new template, and the physical item module may present (e.g., on the administrator computing device 150) potential physical items to add (e.g., as slots) to the new template. The template module 124 may the create the new template (e.g., based on selections sent from the administrator computing device 150).

### Exemplary Computer-Implemented Methods

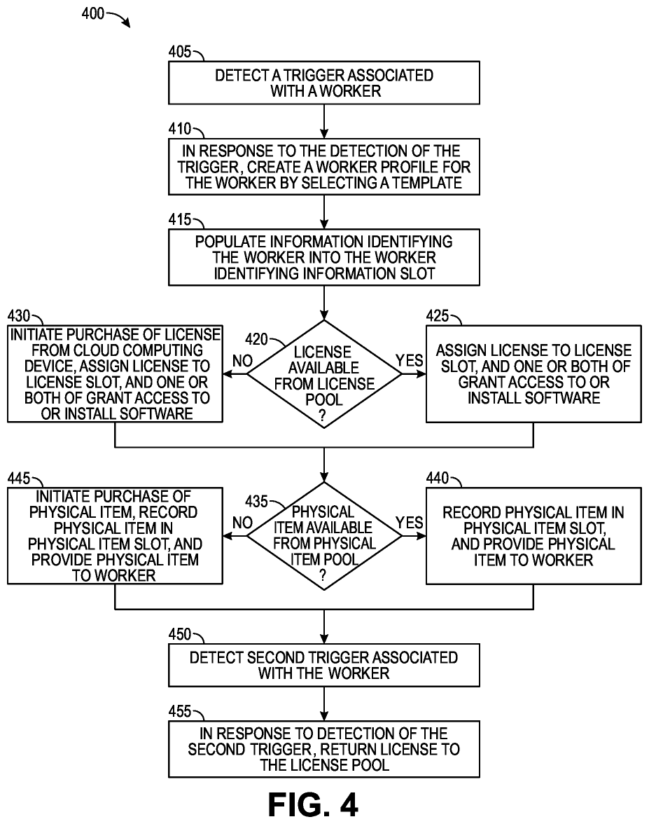

FIG. 4 depicts an exemplary computer-implemented method 400 of onboarding and removing a worker, according to some aspects. In some embodiments, the blocks of the example method 400 may be performed by the one or more processors 120. However, it should be understood that any of the blocks may be performed by any suitable component (e.g., the administrator computing device 150, the cloud computing device 140, the worker computing device 160, etc.).

The example method 400 begins when the one or more processors 120 detect a trigger associated with the worker 162 (block 405). In some embodiments, the trigger indicates that the worker 162 is to be onboarded to the company. Examples of the trigger include adding information of the worker 162 to a database, such as the internal database 118 or the external database 180. Other examples include a signal (e.g., from the administrator computing device 150 or any other suitable component) that the worker 162 is to be onboarded. It may be noted that, in some embodiments, this trigger is a first trigger, as a second trigger may later be provided, as will be discussed below.

Advantageously, embodiments that include the trigger as adding information of the worker 162 to a database improve over prior systems. For example, these embodiments reduce the amount of signals that must be sent through the system. For instance, in a system without detection of such a trigger, the administrator computing device 150 would send both the worker's 162 information to the database, and a separate signal to the management server 102 to onboard the worker 162.

At block 410, in response to detection of the trigger, a worker profile may be created for the worker 162. To create the profile, the one or more processors 120 may select a template. To this end, the template may be selected from a set of templates stored at in the memory 122, the internal database 118, and/or the external database 180. The template may be selected based on any suitable criterial. For example, the template may be selected based on a job type of the worker 162. For instance, there may be different templates for an accounts receivable clerk, a software engineer, a human resources person, a data scientist, an accountant, etc. Additionally or alternatively, the template may be selected based on a seniority level of the worker 162 (e.g., a template for a higher seniority has license slots for more licenses than a template for a lower seniority level, etc.).

As mentioned above, the templates may include slot(s) for any suitable information. For example, a template may include worker identifying information slot(s), license slot(s), physical item slot(s), etc. Furthermore, the license slots may be for particular types of licenses. For example, a template for an accounts receivable clerk may have a license slot for an email account, and a license slot for a word processing program.

In some embodiments, the templates are created by the administrator 152. For example, the administrator 152 may create a template for a particular worker type with a particular seniority level that includes slots for specific licenses and specific physical items.

At block 415, the one or more processors 120 populate information identifying the worker 162 into the selected template. Examples of the worker identifying information include the worker's name, social security number, birthdate, address information, etc.

At block 420, the one or more processors 120 determine if a license with a license type corresponding to the license slot is available from the license pool. If so, at block 425, the one or more processors 120 assign the license to the license slot, and one or both of (a) grant the worker computing device 160 access to the software corresponding to the license, or (b) install the software corresponding to the license on the worker computing device 160. Access to the software may be granted via any suitable technique. For example, the software may be run from a computer or server (e.g., the cloud computing device 140) that is remote from the worker computing device 160. Additionally or alternatively, the access may be granted via a thin client.

In another example, to grant access to the software, a license key is provided to the worker 162. To this end, the license key may be associated with the worker 162, and/or stored in the internal database 118 and/or the external database 180. For instance, the license key may be added to the profile of the worker 162.

Additionally or alternatively, in some examples, access may be controlled by toggling one or more flags. For example, each user 162 may have a one-to-many relationship to software packages (e.g., in the cloud computing device 140, the external database 180, and/or the internal database 118), where each software package has a flag set to “1” if the user has access and set to “0” if the user does not have access.

If, at block 420, the license is not available, at block 430, the one or more processors 120 initiate the purchase of the license (e.g., from cloud computing device 140, etc.), assign the license to the license slot, and one or both of (a) grant the worker computing device 160 access to the software corresponding to the license, or (b) install the software corresponding to the license on the worker computing device 160.

In some aspects, the processor 120 grants access to third party products, such as the third party computation tools depicted below in FIG. 2, and/or to products whose licensing is owned/controlled by the company. An administrator may view software keys, update keys, and delete keys to control access to these access grants.

At block 435, the one or more processors 120 determine if a physical item is available from the physical item pool. For example, if the selected template includes a slot for a particular type of laptop, the one or more processors 120 may determine if the particular type of laptop is available from the physical item pool. If so, at block 440, the one or more processors 120 may record the physical item in the physical item slot of the template. The physical item may then be provided to the worker 162.

If the physical item is not available from the physical item pool, at block 445, the one or more processors may initiate the purchase of the physical item (e.g., from any suitable vendor, etc.), and record the physical item in the physical item slot of the template. And the physical item may then be provided to the worker 162 (e.g., when the physical item arrives from the vendor).

Furthermore, as will be described elsewhere herein, the physical item may be purchased according to one or more parameters. For example, if physical item is a shoe, the shoe may be purchased according to a parameter of a shoe size. In another example, if the physical item is a uniform, the physical item may be purchased according to a clothing size.

At block 450, the one or more processors 120 detect a second trigger. In some embodiments, the second trigger indicates that the worker 162 will end employment with the company (e.g. the employee is to be offboarded). Examples of the second trigger include a signal (e.g., from the administrator computing device 150, the worker computing device 160, or any other suitable component) that the worker 162 will end employment with the company. In some aspects, triggers to end employment may be detected by the present techniques. These triggers may be triggered by events that occur within other systems (e.g., a payroll system event, an active directory access shutoff, etc.) and/or by business rules.

At block 455, in response to the detection of the second trigger, the one or more processors 120 return the license to the license pool. Further, at block 455, the one or more processors 120 may record, in the physical item pool, that the physical item is now available (e.g., by recording an indication in the physical item pool that the physical item is available). In addition, the physical item may then be physically placed in a storage area (e.g., a warehouse, a storage room, etc.), and the location of the physical item may be recorded in the physical item pool.

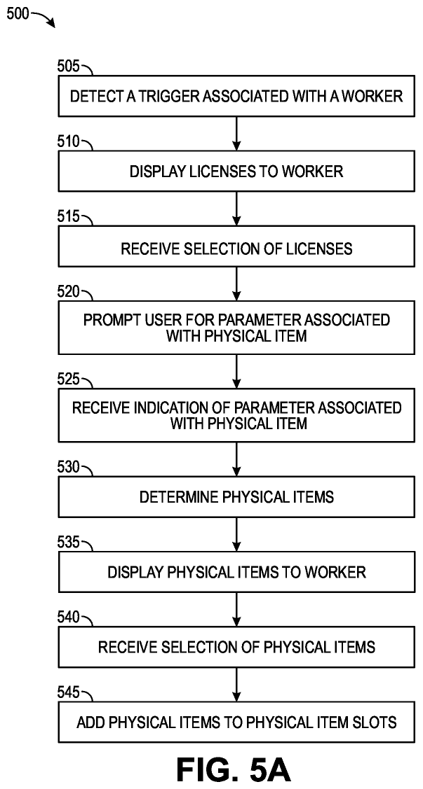

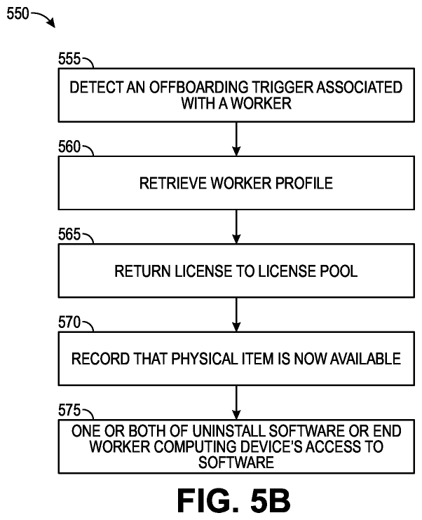

In addition, in some embodiments, the worker 162 may select licenses and/or physical items. In this regard, FIG. 5A depicts an exemplary computer-implemented method 500 of receiving selections of license and physical items, according to some aspects. In some embodiments, the bocks of the example method 500 may be performed by the one or more processors 120. However, it should be understood that any of the blocks may be performed by any suitable component (e.g., the administrator computing device 150, the cloud computing device 140, the worker computing device 160, etc.).

The example method 500 begins when the one or more processors 120 detect a trigger associated with the worker 162 (block 505). In some embodiments, block 505 is similar to block 405 of FIG. 4.

At block 510, licenses are displayed to the worker 162. For instance, the one or more processors 120 may cause a selection of licenses to be displayed on the worker computing device 160. The example screen 200 of FIG. 2 illustrates one such example of licenses 210 being displayed for selection. The licenses to be displayed to the worker 162 may be determined by any suitable technique. For example, the displayed licenses may be determined based on the worker's 162 job type and/or seniority level (e.g., a template for a particular job type and seniority level has license slots for particular types of licenses). Additionally or alternatively, the licenses may be determined based on availability at the license pool. Additionally or alternatively, the licenses may be determined based on costs of the licenses.

At block 515, the one or more processors 120 receive a selection of license(s) (e.g. from the worker computing device 160).

At block 520, the worker 162 is prompted (e.g., at the worker computing device 160) for a parameter associated with a physical item. In some embodiments, the parameter(s) prompted for are based on a type of physical item indicated by the physical item slot of the template. For example, if the physical item is a shoe, the worker 162 may be prompted to enter her shoe size as the parameter. Other examples of parameters include clothing sizes, color preferences (for any physical item), etc.

At block 525, the one or more processors 120 receive an indication of the parameter associated with the physical item (e.g., from the worker computing device 160).

At block 530, the one or more processors 120 determine physical items to display for selection to the worker 162. The physical items may be determined based on any suitable criteria. For example, the physical items may be determined based on: a type of physical item indicated by the physical item slot of the template, parameter(s) received at block 525 (e.g., a parameter indicated a preference for a brown shoe so only brown shoes are displayed), availability of physical items in the physical item pool, availability of physical items from vendors, cost of the physical items, etc.

At block 535, representations of the determined physical items are displayed to the worker 162. For example, the one or more processors 120 may cause the determined physical items to be displayed on the worker computing device 160. In this regard, FIG. 3 illustrates an example screen 300 of physical items 310 displayed to the worker 162.

At block 540, the one or more processors 120 may receive a selection of physical item(s) (e.g., from the worker computing device 160).

At block 545, the selected physical items are added to the physical item slots of the worker profile.

FIG. 5B depicts an exemplary computer-implemented method 550 of offboarding a worker 162, according to some aspects. In some embodiments, the bocks of the example method 550 may be performed by the one or more processors 120. However, it should be understood that any of the blocks may be performed by any suitable component (e.g., the administrator computing device 150, the cloud computing device 140, the worker computing device 160, etc.).

The example method 550 begins when the one or more processors 120 detect an offboarding trigger associated with the worker 162 (block 555). In some embodiments, the offboarding trigger corresponds to the second trigger of block 450 of FIG. 4. In some embodiments, the offboarding trigger indicates that the worker 162 will end employment with the company (e.g. the employee is to be offboarded). Examples of the offboarding trigger include a signal (e.g., from the administrator computing device 150, the worker computing device 160, or any other suitable component) that the worker 162 will end employment with the company. In some aspects, a transfer of a worker from one job function to another (and/or from one company department or organizational chart move) may be an onboarding and/or offboarding trigger.

At block 560, the one or more processors 120 retrieve a worker profile corresponding to the worker 162. This may be done based on identifying information in the offboarding trigger signal. The worker profile may be retrieved from any suitable source (e.g., the memory 122, the internal database 118, and/or the external database 180).

Such worker profiles are described in more detail elsewhere herein. In some examples, the retrieved worker profile includes (i) a worker identifying information slot populated with information identifying the worker 162, (ii) a license slot populated with a license assigned to the license slot, and (iii) a physical item slot with a physical item added to the physical item slot.

At block 565, the one or more processors 120 return a license (e.g., from the license slot of the retrieved worker profile) to the license pool. Returning the license upon detection of the offboarding trigger illustrates advantages over prior systems. For example, in prior systems, the license would have to be manually accounted for, or information sent to the software vendor (e.g., the owner of the cloud computing device 160 to keep track of available licenses). In this regard, the automatic return of the license upon detection of the offboarding trigger advantageously (i) improves the speed at which the license becomes available to a worker 162, and (ii) reduces the risk that the license is not inadvertently lost track of.

At block 570, the one or more processors 120 may record, in the physical item pool, that the physical item is now available (e.g., by recording an indication in the physical item pool that the physical item is available). In addition, the physical item may then be physically placed in a storage area (e.g., a warehouse, a storage room, etc.), and the location of the physical item may be recorded in the physical item pool.

Moreover, recording the physical item upon detection of the offboarding trigger illustrates advantages over prior systems. For example, in prior systems, the physical would have to be manually accounted for (e.g., the administrator 152 would have to record the physical item in a spreadsheet). In this regard, the automatic recording of the physical item upon detection of the offboarding trigger advantageously (i) improves the speed at which others at the company are aware of the availability of the physical item, and (ii) reduces the risk that the physical item is not inadvertently lost track of.

At block 575, the one or more processors 120 one or both of (a) uninstall the software corresponding to the license from the worker computing device 160, or (b) end the worker computing device's 160 access to the software corresponding to the license. For example, in some aspects, the one or more processors 120 may delete a software access key or other information from a database (e.g., the database 180 and/or the database 118).

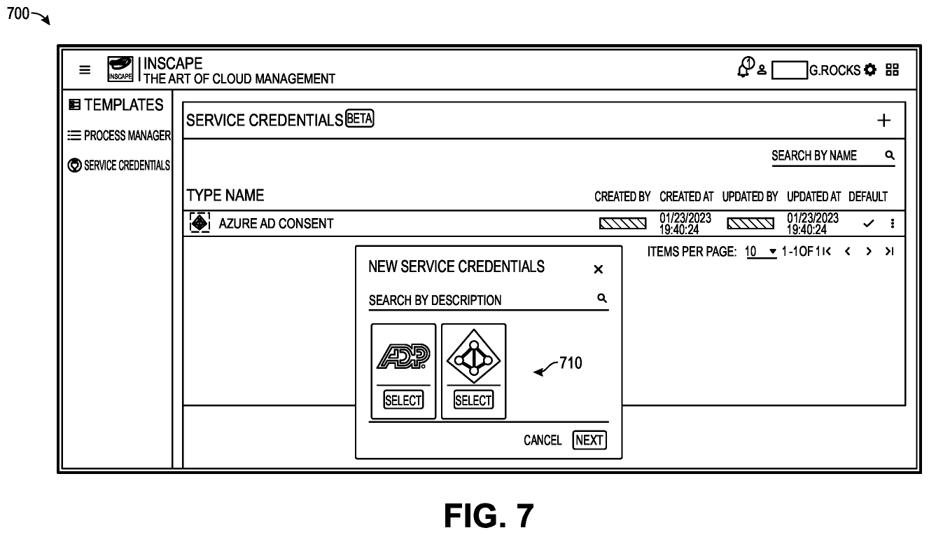

In addition, at any point in time, the administrator 152 (e.g., via the administrator computing device 150) may add, edit, or revoke access to a license. To this end, FIG. 7 illustrates an example screen 700 enabling the administrator 152 to add, edit, or revoke access to a license. For instance, the licensing module 126 may cause the example screen 700 to be displayed on the administrator computing device 150. The example screen 700 includes options for licenses 710 for apps, which the administrator 172 may select from to add, edit, or revoke access to.

Further regarding the example methods 400, 500, 550, it should be noted that all blocks are not necessarily required to be performed. Moreover, additional blocks may be performed although they are not specifically illustrated in the example methods 400, 500, 550. In addition, block(s) from any of the example methods 400, 500, 550 may be performed in the other of the example methods 400, 500, 550 at any point in any of the example methods 400, 500, 550.

Moreover, the systems and methods described herein advantageously represent an improvement to an existing technology(ies), namely technologies for onboarding and offboarding workers. Existing solutions for onboarding and/or offboarding workers are cumbersome, and further include many signals being sent throughout the system. Techniques described herein streamline the process, resulting in a better user experience. Furthermore, the techniques described herein reduce the number of signals sent throughout the system. For example, in conventional systems, the purchase/licensing of items (e.g., physical items, cloud-based software/services, etc.) from a catalog must be performed as a separate manual step by the licensee, using a separate catalog website. On the other hand, the present techniques add the technical capability to the present techniques of automatically obtaining/licensing items via a seamlessly integrated licensing procedure that is not presented to the customer as a separate website. Therefore, the present techniques improve upon conventional automated licensing computer systems by (1) reducing the number of independent computing systems (and attendant resources) that the company must maintain, thereby lowering overall resources consumption and increasing efficiency while reducing complexity; and (2) reducing the number of computing services that a customer needs to use in order to effectuate obtaining a license.

In particular, the disclosed use of templates reduces the amount of signals that must be sent though the system. For instance, in a system that does not use such templates, the administrator 152 must indicate which types of licenses are to be provided to a new worker 162 each time a new worker 162 is onboarded (e.g., more data must be sent from the administrator computing device 150 to the management server 102 each time a worker is onboarded). Advantageously, techniques described herein reduce the amount of signals that must be sent throughout the system because of the disclosed use of templates. Indeed, in some embodiments, to create the worker profile, by use of such templates, no (or very little) data must be sent from the administrator computing device 150 to the management server 102.

In another advantage, the technical functioning is improved by the one or more processors 120 initiating the purchase of a license corresponding to a license slot of a template. For instance, this reduces the amount of signals that must be sent throughout the system. For example, to purchase a new license corresponding to a license slot of a template, the administrator computing device 150 does not have to send a signal to the management server 102, which is then in turn followed by a purchase command from the management server 102 to the cloud computing device 140. Moreover, this results in a better user experience. For example, the administrator 152 does not have to manually enter commands to purchase licenses.

In yet another advantage, embodiments that include the trigger as adding information of the worker 162 to a database (e.g., at block 405 of FIG. 4) improve over prior systems. For example, these embodiments reduce the amount of signals that must be sent through the system. For instance, in a system without detection of such a trigger, the administrator computing device 150 would send both the worker's 162 information to the database, and a separate signal to the management server 102 to onboard the worker 162.

In still another advantage, the technical functioning is improved by detecting the second trigger (e.g., block 450 of FIG. 4), and returning the license to the license pool in response to the detection (e.g., block 455 of FIG. 4). For example, in a system that did not detect the second trigger, the administrator 152 would have to manually return the license to the license pool when the worker 162 was offboarded. Moreover, the detection of the second trigger advantageously avoids the pitfall of the administrator 152 inadvertently neglecting to return the license to the license pool upon worker 162 departing the company.

Moreover, these improvements streamline the process of onboarding and offboarding. For example, the administrator 152 may create a template with potential licenses for the worker 162. The worker 162 may then, in turn, select from the potential licenses, thus streamlining the process from both the administrator's 152, and the worker's 162 perspectives.

### Exemplary Template Creation

In some embodiments, the templates may be created by the administrator 152 or other user. For example, the administrator 152 may create templates for particular job types and/or seniority levels.

In some such examples, the administrator 152 (e.g., via the administrator computing device 150) specifies which licenses are to be provided in the template (e.g., by selecting from a screen similar to the example screen 200 of the example of FIG. 2). The screen presented to the administrator 152 may also show the job type and/or seniority level that the template is for.

Additionally or alternatively, the administrator 152 (e.g., via the administrator computing device 150) may specify which physical items are to be provided in the template (e.g., by selecting from a screen similar to the example screen 300 of the example of FIG. 3). The screen presented to the administrator 152 may also show the job type and/or seniority level that the template is for.

Upon receipt of the selections, the one or more processors 120 may create the template including slots for the selected license(s) and/or physical item(s).

### Exemplary Workflow Creation

In some embodiments, workflows for onboarding of workers 162 may also be created (e.g., by the administrator 152 via the administrator computing device 150).

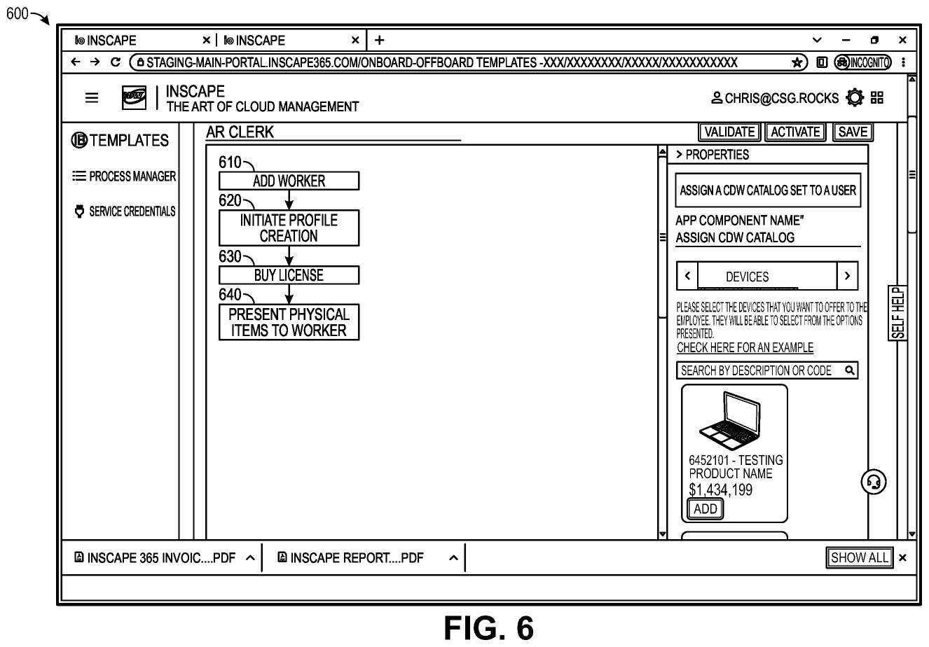

To this end, FIG. 6 illustrates an example screen 600 for creating an onboarding workflow for an AR clerk. For instance, on the example screen 600, the administrator 152 may drag the blocks 610, 620, 630, 640 to change the order of the blocks. The administrator 152 may also add blocks, remove blocks, etc. The user/administrator may create templates, as shown below in FIG. 6. The user may add one or more blocks to the template, wherein each block corresponds to respective computer-executable instructions.

In the illustrated example, block 610 represents the addition of a worker (e.g. detection of a trigger, such as in blocks 405 and/or 505). Block 620 represents initiation of creation of the worker profile (e.g., selection of a template, such as in block 410).

Block 630 represents buying of licenses to assign to the license slot(s). However, it should be noted that the administrator 152 may insert an intervening block between blocks 620 and 630 to first search the license pool to determine if the license(s) are available. In addition, upon purchase of the license(s), the license(s) may be assigned to the license slot(s) of the profile.

Block 640 represents presentation of physical items to the worker 162 to select from (e.g., such as in block 535). Following the selection from the worker 162, the selected physical items may be added to the physical item slots of the profile.

### Other Matters

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computing system for improved automated electronic onboarding or offboarding of a worker, comprising:
one or more processors; and
a memory having stored thereon instructions that, when executed by the one or more processors, cause the system to:
detect, via the one or more processors, a trigger associated with the worker;
in response to the detection of the trigger, create, via the one or more processors, a worker profile for the worker by selecting a template based on a job type of the worker, wherein the selected template comprises: (i) a worker identifying information slot, (ii) a license slot, and (iii) a physical item slot;
populate, via the one or more processors, information identifying the worker into the worker identifying information slot;
determine, via the one or more processors, if a license with a license type corresponding to the license slot is available in a license pool;
if the license is available in the license pool, via the one or more processors: (i) assign the license to the license slot, and (ii) one or both of (a) install, on a worker computing device, software corresponding to the license, or (b) grant the worker computing device access to the software corresponding to the license; and
if the license is not available in the license pool, via the one or more processors: (i) initiate a purchase of the license from an cloud computing device, and (ii) one or both of (a) install, on the worker computing device, the software corresponding to the license, or (b) grant the worker computing device access to the software corresponding to the license.

2. The computing system of claim 1, wherein the trigger comprises an addition of information of the worker to a database.

3. The computing system of claim 1, the memory having stored thereon instructions that, when executed by the one or more processors, cause the system to:
detect, via the one or more processors, a second trigger; and
in response to the detection of the second trigger, return, via the one or more processors, the license to the license pool.

4. The computing system of claim 3, wherein the second trigger comprises an indication that the worker will end employment with a company.

5. The computing system of claim 1, wherein the license type is an email account license, a word processing license, or an app license.

6. The computing system of claim 1, the memory having stored thereon instructions that, when executed by the one or more processors, cause the system to:
determine, via the one or more processors, a set of physical items based on a physical item type corresponding to a type of physical item of the physical item slot;
display, via the one or more processors, representations of physical items of the set of physical items on a computing device;
receive, via the one or more processors and from the computing device, a selection of a physical item of the set of physical items; and
add, via the one or more processors, an indication of the physical item to the physical item slot.

7. The computing system of claim 6, wherein the computing device is a worker computing device of the worker, or an administrator computing device of an administrator.

8. The computing system of claim 6, the memory having stored thereon instructions that, when executed by the one or more processors, cause the system to determine the set of physical items further by:
receiving, via the one or more processors, an indication of a parameter associated with the physical item; and
determining, via the one or more processors, the set of physical items further based on the parameter.

9. The computing system of claim 1, wherein the job type is an accounts receivable manager, an accountant, or a software engineer.

10. The computing system of claim 1, the memory having stored thereon instructions that, when executed by the one or more processors, cause the system to create the template by:
presenting, via the one or more processors and at an administrator computing device: (i) a plurality of license types, and (ii) an indication of the job type;
receiving, via the one or more processors and from the administrator computing device, a selection of at least one license type of the plurality of license types;
setting, via the one or more processors, the license type corresponding to the license slot to be for the selected at least one license type; and
setting, via the one or more processors, the template to correspond to the job type.

11. A non-transitory computer readable medium containing program instructions that when executed, cause a computer to:
detect, via one or more processors, a trigger associated with a worker;
in response to the detection of the trigger, create, via the one or more processors, a worker profile for the worker by selecting a template based on a job type of the worker, wherein the selected template comprises: (i) a worker identifying information slot, (ii) a license slot, and (iii) a physical item slot;
populate, via the one or more processors, information identifying the worker into the worker identifying information slot;
determine, via the one or more processors, if a license with a license type corresponding to the license slot is available in a license pool;
if the license is available in the license pool, via the one or more processors: (i) assign the license to the license slot, and (ii) one or both of (a) install, on a worker computing device, software corresponding to the license, or (b) grant the worker computing device access to the software corresponding to the license; and
if the license is not available in the license pool, via the one or more processors: (i) initiate a purchase of the license from an cloud computing device, and (ii) one or both of (a) install, on the worker computing device, the software corresponding to the license, or (b) grant the worker computing device access to the software corresponding to the license.

12. The non-transitory computer readable medium of claim 11, wherein the trigger comprises an addition of information of the worker to a database.

13. The non-transitory computer readable medium of claim 11, containing further program instructions that when executed, cause the computer to:
detect, via the one or more processors, a second trigger; and
in response to the detection of the second trigger, return, via the one or more processors, the license to the license pool.

14. The non-transitory computer readable medium of claim 13, wherein the second trigger comprises an indication that the worker will end employment with a company.

15. The non-transitory computer readable medium of claim 11, wherein the license type is an email account license, a word processing license, or an app license.

16. The non-transitory computer readable medium of claim 11, containing further program instructions that when executed, cause the computer to:
determine, via the one or more processors, a set of physical items based on a physical item type corresponding to a type of physical item of the physical item slot;
display, via the one or more processors, representations of physical items of the set of physical items on a computing device;
receive, via the one or more processors and from the computing device, a selection of a physical item of the set of physical items; and
add, via the one or more processors, an indication of the physical item to the physical item slot.

17. The non-transitory computer readable medium of claim 11, wherein the computing device is a worker computing device of the worker, or an administrator computing device of an administrator.

18. A computer-implemented method for improved automated onboarding or offboarding of a worker, comprising:
detecting a trigger associated with the worker;
in response to the detection of the trigger, creating a worker profile for the worker by selecting a template based on a job type of the worker, wherein the selected template comprises: (i) a worker identifying information slot, (ii) a license slot, and (iii) a physical item slot;
populating information identifying the worker into the worker identifying information slot;
determining if a license with a license type corresponding to the license slot is available in a license pool;
if the license is available in the license pool: (i) assigning the license to the license slot, and (ii) one or both of (a) installing, on a worker computing device, software corresponding to the license, or (b) granting the worker computing device access to the software corresponding to the license; and
if the license is not available in the license pool: (i) obtaining the license from an cloud computing device, and (ii) one or both of (a) installing, on the worker computing device, the software corresponding to the license, or (b) granting the worker computing device access to the software corresponding to the license.

19. The computer-implemented method of claim 18, wherein the trigger comprises an addition of information of the worker to a database.

20. The computer-implemented method of claim 18, wherein the license type is an email account license, a word processing license, or an app license.
